(19) United States
(12) Patent Application Publication
(10) Pub. No.: US 2008/0245276 A1
(43) Pub. Date: Oct. 9, 2008

(54) LINING MORTAR

(75) Inventor: Antonio M. Gomes, Itajuba (BR)

Correspondence Address: COLLARD & ROE, P.C., 1077 NORTHERN BOULEVARD, ROSLYN, NY, 11576, US

(73) Assignee: MASSAFACIL IND. COM. ARGAMASSA, LTDA, Itajuba (BR)

(21) Appl. No.: 11/696,206

(22) Filed: Apr. 4, 2007

(51) Int. Cl. C04B 7/32

(52) U.S. Cl. 106/802

(57) ABSTRACT

A lining mortar developed for applications in Civil Construction (new works, renovations and maintenance in general). The lining mortar composition comprises an inorganic filler in the form of aluminum silicate which has a wt % between approximately 20% and 38%. Other components can include an inorganic filler in the form of Hemihydrate which has a wt % between approximately 12% and approximately 30%. In addition other components include a binder in the form of an aqueous dispersion of acrylic-styrene copolymer having a wt % between approximately 4% and approximately 16%; and water having a wt % between approximately 34% and approximately 46%.

### BACKGROUND OF THE INVENTION

This invention relates to a lining mortar developed for applications in civil construction (new works, renovations and maintenance in general). More particularly, this invention relates to a lining mortar containing aluminum silicate, hemihydrate, which is a hydrate in which the molecular ratio of water molecules to anhydrous compound is 1:2, an anionic aqueous dispersion of acrylic-styrene co-polymer, and water which, is prepared by conventional means, such as by simple mixing of the various components at ambient temperature. The resulting product offers excellent characteristics as linings for a variety of substrates such as in structural block masonry—sealing masonry in cellular concrete block, sical block, ceramic block—drywall walls sheets of weathered gypsum, slabs of gypsum or smooth gypsum (plaster)—polystyrene (EPS)—vitreous or enamelled, ceramic surfaces—panels of solid wood, plywood or agglomerate—plastered, pointed, tiled or painted surfaces—ceramics and rigid surfaces of PVC (plastic laminates).

### SUMMARY OF THE INVENTION

At least one embodiment of the invention relates to a lining mortar that includes (1) Aluminum Silicate (SiO₂+Al₂O₃), (2) Hemihydrate having a composition of (CaSO₄.0.5H₂O), (3) an anionic aqueous dispersion of acrylic-styrene copolymer, and (4) water (H₂O).

This invention allows for the combination of the individual characteristics of each component for obtaining a mortar with fast hardening and fast drying (rapid setting), high plasticity, consistency and adherence, which lends speed in job performance. This component leads to high productivity and gains in efficiency. In addition, this component offers mechanical properties compatible with acting stresses, mainly excellent adherence to various types of substrates, which impart good performance thereto during use; minimum shrinkage through drying, reducing the risk of early cracking; excellent surface finish and resistance to moisture for limited time—of intermittent form. The components allow for adequate binding time in order to avoid waste of material and labor.

### DETAILED DESCRIPTION OF PREFERRED EMBODIMENTS

This composition can include inorganic filler (mineral load) of Aluminum Silicate (SiO₂+Al₂O₃), known commercially as calcined China clay, used in the form of powder insoluble in water, in the processed white color or in the color in nature, odorless, non-inflammable, non-perishable, non-poisonous, with low grain size measurement (fine)—retention between #200 Mesh and #600 Mesh. This aluminum silicate may range in weight (wt %) between approximately 20% and approximately 38% of the composition of fresh mortar for application.

The inorganic filler of hemihydrate (CaSO₄.0.5H₂O), made up predominantly of sulfates (hemihydrate, anhydrite or gypsite), known commercially as gypsite—hidrous calcium sulphate. This gypsite is dehydrated by a calcination process, and is known commercially as loose gesso or even construction gesso, which may or may not contain additives for controlling binding. This Hemihydrate is used in the form of powder insoluble in water, in the color white, odorless, non-inflammable, non-perishable, non-poisonous, and which may range in weight between approximately 12% and approximately 30% (wt %) of the composition of fresh mortar for application.

The binder can be in the form of an anionic aqueous dispersion of acrylic-styrene copolymer, with a solids content ranging between 41% and 51%. The component can have a Brookfield viscosity RVT F6/20 rpm at 25° C. (cPs) ranging between 8,000 and 12,000, pH at 25° C. ranging between 8 and 9, with milky white liquid appearance, having water as its thinner. This component can range in weight between approximately 4% and approximately 16% (wt %) of the composition of fresh mortar for application.

The water for mixing (H₂O), is usually clean and with no impurities, and which can range in weight between approximately 34% and approximately 46% (wt %) of the composition of fresh mortar for application.

Also, this composition can include, optionally, pigments, for coloration of the mortar.

The composition according to this invention may be used in order to provide a lining for a variety of substrates. The examples to follow illustrate this invention with presentation of the respective results of technological tests performed by the Civil Construction Materials Laboratory of the Infrastructure Works Technology Center of the Technology Research Institute—IPT of the State of S{tilde under (a)}o Paulo/Brazil.

### EXAMPLE 1

In the first example or embodiment, this embodiment is known by its code name as: MFBrIn. A review was conducted on Oct. 21, 2006. The components of this first embodiment in this review include an 8% anionic aqueous dispersion of acrylic-styrene co-polymer. In the end, the components were considered Anionic. These components were used as a lining for dry interior environments. The components of the first embodiment are as follows: inorganic filler (mineral load) of Aluminum Silicate (SiO₂+Al₂O₃)—#325 Mesh: 32% by weight of the composition of fresh mortar for application. Another component includes Agglomerative Hemihydrate (CaSO₄.0.5H2O): approximately 18% by weight of the composition of fresh mortar for application. In this case, there can also be a binder which is in the form of an anionic aqueous dispersion of acrylic-styrene copolymer: approximately 8% by weight (wt %) of the composition of fresh mortar for application. In addition the entire set of components can be mixed together. For example, the water for mixing (H₂O) is: approximately 42% by weight of the composition of fresh mortar for application.

Next after manufacture, an analysis of the technological tests for characterization and performance of this first embodiment used for lining mortar for dry interior environments. The result of tests on mass density in the fresh state—1.37 g/cm³, and hardened state—0.79 g/cm³, shows that embodiment is considerably lighter than conventional mortar for lining of walls, and other similar mortars and pastes, that is, this embodiment overloads the construction superstructure less.

In addition, the result of tests on volumetric shrinkage—6%, shows the adequacy of this embodiment in relation to the technical premise that limits the shrinkage of a lining mortar to 35% at most.

The result of tests on water absorption at a rate of 10% shows the adequacy of the present invention in relation to the technical premise that limits the water absorption of PVA Extended Mass (product used in Brazil for wall finish) to 15% at most.

The result of tests on resistance to abrasion—1.53 g of mass removed, shows the adequacy of the present invention in relation to the technical premise that limits the mass removed from PVA extended mass to 10 g, that is, very easy sanding.

The results of tests on potential tensile bond strength—0.44 MPa on an enameled ceramic slab, and approximately 1.10 MPa on a concrete block. These tests show the adequacy of the present invention in relation to the technical premise that limits adherence of a lining mortar to a minimum of 0.30 MPa. Thus, if we analyze the results for each test substance, we can conclude that these values, are still greater in practice, since the types of fracture, in their great majority, were coating fracture, and not separation of the coating at the substrate-lining interface. In any case, the present invention possesses excellent adherence, including on enameled and/or vitreous surfaces, which is quite exceptional and positive for linings for civil construction.

The result of tests on water permeability shows the embodiment of the present invention in a lining thickness of 3 mm, acts as a barrier to the penetration of water into the substrate for a period of 3 hours. In this case, the embodiment of the present invention is not impermeable, but it can be washed, which of course is very good, since it protects the substrate for some time and resists the presence of water.

The result of tests on water evaporation shows that the embodiment of the present invention allows the discharge of water/moisture existing in the substrate, that is, it offers a high power of hygroscopic equilibrium and thermal comfort.

In addition, the results of tests on paint adherence resistance with adhesive tape, and coverage capability of latex paint demonstrate that the adherence and the performance of latex paint on with the present invention are satisfactory.

As for the results of tests on tensile strength in Flexure—1.42 MPa and in Compression—2.27 MPa, as well as Hardness—3.69 N/mm² and Compressive Strength—1.98 MPa, and Capacity to Conceal Cracks, 0.11 mm, they show that the present embodiment meets the pre-requisites for the purpose for which it is intended.

The results of the tests indicate that the present embodiment is a quality product with technical-economic viability, since in addition to involving an innovative product, it offers a good cost-benefit ratio, therefore the inclusion of some gesso tests, for comparative purpose.

### Preparation of the Mortar:

This mortar is a two-component product (powder and additive), supplied in plastic packages, one being of 10 kg for the powder and the other of 0.8 kg for the additive.

For applications in dry interior environments, the mortar can be prepared in the proportion of 1 bag of powder, 2 bags of additive, and 8.4 liters of water.

In this case, a user can use clean watertight plastic containers (mud pan and bucket), and water available at the worksite (free of residues and impurities), mix the additive and the water in the bucket, in the quantities required for the application. Next, the water-additive solution can be emptied into the mud pan in the desired quantity for slow addition of the powder, wherein it is sprinkled in, allowing it to steep until total soaking of the powder. After this period, with the aid of a PVC spatula, the mortar is mixed until obtaining a homogeneous pasty mixture, without dry clots, for use.

To prevent any inhalation or exposure, goggles and protective gloves, can be used as well as an air-purifying respirator in the handling of the product. Once the mortar has been prepared, it can be applied by spreading the mortar and smoothing the mortar on the surface.

Next, with the aid of a flexible PVC trowel, a first layer of the mortar (thin base layer), can be spread striving to cover the entire surface. Next, after drying of this first layer, the second layer of mortar, can be applied taking care with vertical and horizontal alignment and the existence of surface undulations or defects which should be corrected in order to leave the wall in condition for final finishing.

Next, when the applied mortar is sufficiently hardened, the fine finishing can be performed so that it is smoothed out using a flat trowel of steel, or even of flexible PVC, in order to leave the surface in better condition for sanding.

Before applying this mortar, it should be dry, firm, free of loose or poorly attached parts and free of dirt, such as dust, grease, fungi, lubricants or oils, which might be detrimental to adherence of the mortar. Next, holes and joints should be filled in, ridges of mortar, wires and nails being removed. If it is dry and highly absorbent, it should be moistened moments prior to application. In addition, tiled, enameled, vitreous or PVC surfaces should receive a thin layer of this embodiment solution wherein there is a water-additive solution prior to application, with the aid of an paint-brush or paint-roller.

### EXAMPLE 2

Another example or embodiment can be used as well. For example, a solution with the code MFBrEx can be used. This solution was tested on Oct. 21, 2006. This solution was 12% (wt %) anionic aqueous dispersion of acrylic-styrene copolymer. In the end it still formed an anionic solution. This solution was also used for the lining for interior and exterior environments.

With this second example, an inorganic filler (mineral load) of Aluminum Silicate (SiO2+Al2O3)—#325 Mesh: 32% by weight of the composition of fresh mortar for application.

In addition, an Agglomerative Hemihydrate (CaSO₄.0.5H2O): 18% by weight of the composition of fresh mortar for application can be added to this solution. Furthermore, other components such as a binder anionic aqueous dispersion of acrylic-styrene copolymer: approximately 12% (wt %) by weight of the composition of fresh mortar for application can be added to this solution. Next, water could be used for mixing the amount of water to be used could be (H2O): approximately 38% by weight of the composition of fresh mortar for application.

Analysis of the technological tests for characterization and performance of the present embodiment includes lining mortar for exterior and interior environments:

The result of tests on mass density in the fresh state—1.34 g/cm³, and hardened state—1.04 g/cm³, shows that this embodiment is considerably lighter than conventional mortar for lining of walls, and other similar mortars/pastes. In addition this embodiment does not, or is less likely to overload the construction superstructure.

The result of tests on volumetric shrinkage—28.9%, shows the adequacy of this embodiment in relation to the technical premise that limits the shrinkage of a lining mortar to at most 35%. The result of tests on water absorption—5.71%, shows the adequacy of this embodiment in relation to the technical premise that limits the water absorption of Acrylic Mass (product used in Brazil for wall finish) to at most 18%. The result of tests on abrasion resistance—2.29 g of mass removed, shows the adequacy of the present invention in relation to the technical premise that limits the mass removed from acrylic mass to 5 g, that is, very easy sanding.

The results of tests on potential tensile bond strength—0.86 MPa on an enameled ceramic slab, and 1.30 MPa on a concrete block, of extreme importance, show the adequacy of this embodiment in relation to the technical premise that limits adherence of a lining mortar to a minimum of 0.30 MPa. Thus, if we analyze the results for each test substance, these values, are still greater in practice, since the types of fracture, in their great majority, were coating fracture, and not separation of the coating at the substrate-lining interface. In any case, this embodiment possesses excellent adherence, including on enameled and/or vitreous surfaces, which is quite exceptional and positive for linings for civil construction.

The result of tests on water permeability shows that with this embodiment in a lining thickness of 3 mm, acts as a barrier to the penetration of water into the substrate for a period of 24 hours. Ultimately, or that is, this embodiment is not impermeable, but it can be washed, which, of course, is very good, since it protects the substrate for some time and resists the presence of water.

The result of tests on water evaporation shows that the present embodiment allows the discharge of water/moisture existing in the substrate, or that is, it offers a high power of hygroscopic equilibrium and thermal comfort.

The results of tests on paint adherence resistance with adhesive tape, and coverage capability of latex paint demonstrate that the adherence and the performance of latex paint on the present embodiment are satisfactory.

The test results on this embodiment disclose the following: the Tensile Strength in Flexure—2.48 MPa and in Compression—4.03 MPa, as well as Hardness—8.04 N/mm² and Compressive Strength—4.62 MPa, and Capacity to Conceal Cracks—0.26 mm. These tests show that this embodiment meets the pre-requisites for the purpose for which it is intended.

The results of the tests indicate that the present embodiment is a quality product with technical-economic viability, since in addition to involving an innovative product, it offers a good cost-benefit ratio, therefore there is the inclusion of some gesso tests, for comparative purpose.

### Preparation of the Mortar:

With this embodiment, mortar is in the form of a two-component product (powder and additive), which is supplied in plastic packages. One of the packages being of 10 kg for the powder and the other of 0.8 kg for the additive. In addition, for applications in exterior and/or interior environments, the mortar can be prepared in the proportion of 1 bag of powder, 3 bags of additive, and 7.6 liters of water.

Next, clean watertight plastic containers can be used (mud pan and bucket), where in this water can be made available at the worksite (free of residues and impurities). Next the solution is mixed so that the additive and the water are mixed together in a container such as in the bucket, in the quantities required for the application. Next, the water-additive solution is poured into the mud pan in the desired quantity.

Powder, can be sprinkled in, allowing it to steep until total soaking of the powder. After this period, with the aid of a PVC spatula, the mortar is mixed until a homogeneous pasty mixture is obtained without dry clumps, for use.

As stated above, general precautions should be taken. For example, the use of goggles and protective gloves, in addition to an air-purifying respirator in the handling of the product may be beneficial. In addition, fillers may not be appropriate for their biotype, size, form and circumstances.

### Application of the Mortar:

The mortar can be spread and smoothed on the surface. With the aid of a flexible PVC trowel, a first layer of the mortar (thin base layer), can be spread to cover the entire surface. After drying of this first layer, the second layer of mortar, can be applied taking care with vertical and horizontal alignment and the existence of surface undulations or defects which should be corrected in order to leave the wall in condition for final finishing.

When the applied mortar is sufficiently hardened, fine finishing can be performed smoothing the solution using a flat trowel of steel, or even of flexible PVC, in order to leave the surface in better condition for sanding.

When applying this solution certain precautions may be recommended. For example, the surface should be dry, firm, free of loose or poorly attached parts and free of dirt, such as dust, grease, fungi, lubricants or oils, which might be detrimental to adherence of the mortar. Holes and joints should be filled in, ridges of mortar, wires and nails being removed. In addition, if the solution is dry and highly absorbent, it should be moistened moments prior to application. In this case, tiled, enameled, vitreous or PVC surfaces should receive a thin layer of the solution according to the above embodiment wherein water can be added to the solution prior to application, with the aid of an paint-brush or paint-roller.

Ultimately, the unique solution of this product provides for a mortar solution which is greatly improved over the previous mortar solutions.

Accordingly, while a few embodiments of the present invention have been shown and described, it is to be understood that many changes and modifications may be made thereunto without departing from the spirit and scope of the invention as defined in the appended claims.

What is claimed is:

1. A lining mortar composition comprising:
an inorganic filler in the form of aluminum silicate which has a wt % between approximately 20% and 38%;
an inorganic filler in the form of Hemihydrate which has a wt % between approximately 12% and approximately 30%;
a binder in the form of an aqueous dispersion of acrylic-styrene copolymer having a wt % between approximately 4% and approximately 16%; and
water having a wt % between approximately 34% and approximately 46%.

2. The mortar as in claim 1, wherein said Aluminum silicate has a wt % of approximately 32%.

3. The mortar as in claim 1, wherein said Hemihydrate has a wt % of approximately 18%.

4. The mortar as in claim 1, wherein said binder has a wt % of approximately 8%.

5. The mortar as in claim 1, wherein said water has a wt % of approximately 42%.

6. The mortar as in claim 1, wherein said alumunium silicate comprises 32% wt %; said Hemihydrate comprises 18% wt %; said binder comprises 8% wt % and said water comprises 42% wt % of the entire solution.

7. The mortar as in claim 1, wherein said mortar has a mass density in a fresh state of 1.37 g/cm³ and for a hardened state of 0.79 g/cm³.

8. The mortar as in claim 1, wherein said mortar has a volumetric shrinkage of 6%.

9. The mortar as in claim 1, wherein said mortar in its set state has a water absorption of approximately 10%.

10. The mortar as in claim 1, wherein said mortar when set has a resistance to abrasion of 1.53 g of mass removed.

11. The mortar as in claim 1, wherein said mortar when set has a potential tensile bond strength of 0.44 MPa when coupled to an enameled ceramic slab.

12. The mortar as in claim 1, wherein said mortar when set has a potential tensile bond strength of 1.10 MPa on a concrete block.

13. The mortar as in claim 1, wherein said aluminum silicate comprises 32% wt %; said Hemihydrate comprises 18% wt %; said binder comprises 12% wt % and said water comprises 38% wt % of the entire solution.

14. The mortar as in claim 1, wherein said mortar has a tensile strength of approximately 1 MPa in flexure and at least 2 MPa in compression.

15. The mortar as in claim 1, having a hardness of at least 3 MPa.

16. The mortar as in claim 1, wherein said mortar has a compressive strength of at least 1.5 MPa.

17. A mortar composition consisting of:
an inorganic filler in the form of aluminum silicate which has a wt % between 20% and 38%;
an inorganic filler in the form of Hemihydrate which has a wt % between 12% and 30%;
a binder in the form of an aqueous dispersion of acrylic-styrene copolymer having a wt % between 4% and 16%; and
water having a wt % between 34% and 46%.

18. A mortar composition consisting of:
an inorganic filler in the form of aluminum silicate which has a wt % of 32%
an inorganic filler in the form of Hemihydrate which has a wt % of 18%
a binder in the form of an aqueous dispersion of acrylic-sytrene copolymer having a wt % of 12%; and
water having a wt % of 38%.

19. A mortar composition consisting of:
an inorganic filler in the form of aluminum silicate which has a wt % of 32%
an inorganic filler in the form of Hemihydrate which has a wt % of 18%
a binder in the form of an aqueous dispersion of acrylic-styrene copolymer having a wt % of 8%; and
water having a wt % of 42%.
